(19) United States
(12) Patent Application Publication
(10) Pub. No.: US 2008/0188216 A1
(43) Pub. Date: Aug. 7, 2008

(54) SYSTEM AND METHOD FOR MOBILE NETWORK TUNING FIELD MEASUREMENT

(75) Inventors: Wen-Yi Kuo, Taipei City (TW); Yueh-Feng Lee, Taoyuan City, (TW)

Correspondence Address: PAI PATENT & TRADEMARK LAW FIRM, 1001 FOURTH AVENUE, SUITE 3200, SEATTLE, WA, 98154, US

(73) Assignee: BANDRICH INC., SINDIAN CITY (TW)

(21) Appl. No.: 12/100,240

(22) Filed: Apr. 9, 2008

Related U.S. Application Data
(63) Continuation-in-part of application No. 11/625,333, filed on Jan. 21, 2007.

(51) Int. Cl. H04Q 7/34

(52) U.S. Cl. 455/424

(57) ABSTRACT

A system for measuring the performance of a mobile network includes a field measurement device, a server and a built-in command set. The field measurement device continuously scans an assigned frequency of the mobile network to collect measurement data. The server remotely controls the field measurement device by sending the command script via the mobile network to the field measurement device. The built-in command set includes predefined trouble call containing the situation of a low quality event, and indicators for the low quality event is detected by referring to, for example, received signal strength indicator (RSSI). One test sample for any indicator is an average value in a certain user-defined period, and the low quality event will be triggered if the test sample count or ratio reaches a user-defined threshold of any indicator in a judgment window which is a user-defined duration to decide whether the event happens or not.

### RELATED APPLICATIONS

This application is a continuation-in-part of U.S. application Ser. No. 11/625,333, filed on Jan. 21, 2007, hereby incorporated by reference as it fully set forth herein.

### BACKGROUND

1. Field of Invention

The present invention relates to mobile communication networks. More particularly, the present invention relates to a system and method for monitoring the performance of mobile communication networks.

2. Description of Related Art

Network operators have continuously sought to increase the efficiency and utilization of network resources to assure that their customers are able to receive quality communications. It therefore is necessary that the network operator know the strengths and limitations of its network in a complex environment by collecting a number of measurement data and analyzing the measurement data in order to assure that its customers receive uninterrupted and clear service wherever they might be. This network optimization requires extensive performance measurements over the geographic area that the mobile network operator services.

However, network optimization is laborious and time consuming. For example, coverage optimization may be accomplished by varying a number of parameters (e.g. antenna azimuth, antenna tilt, antenna type etc) of a sector, where the sector uses an electromagnetic radiation pattern that is generated by an antenna of a transceiver to define a coverage area. After the parameter has been varied, a fresh set of performance measurements must be made by physically driving around the relevant terrain with a measurement device which creates the desired radio and service conditions in order to take the log on site. This requires investment in a lot of resources and schedule constraints for network optimization.

Furthermore, 3G (for example, WCDMA/UMTS) and 3.5G (for example, HSDPA/HSUPA) networks are now actively being deployed worldwide. It is obvious, for these new technologies, different network deployment optimization work has to be done to achieve better network coverage, utilize network resources and enhance network efficiency.

For the forgoing reasons, there is a need for a mobile network management (e.g. 2G, 2.5G, 3G, 3.5G and WiMAX) system and method that can assist in collecting measurement data for tuning and optimizing the performance of the mobile network.

### SUMMARY

According to one embodiment of the present invention, a system for measuring the performance of a mobile network includes a field measurement device with a global positioning system, a server having application software and a built-in command set listing a plurality of command options to operate the field measurement device. The field measurement device is capable of continuously scanning an assigned frequency of the mobile network to collect measurement data by executing a command script so that the measurement data with geographic location is recorded in a log file. The server is capable of remotely controlling the field measurement device by sending the command script via the mobile network to the field measurement device for execution and in response receiving the log file from the field measurement device via the mobile network, and the log file is imported into the application software to provide analysis and tuning of the mobile network.

The built-in command set is selected from a group consisting of duration or repetition of mobile origination voice call, duration or repetition of mobile termination voice call, duration or repetition of WiMAX origination 64 Kbps circuit-switched call, duration or repetition of mobile termination 64 kbps circuit-switched call, upload or download packet-switched call, file size of packet-switched call, repetition of packet-switched call, test call, predefined trouble call, unit management, unit status update, idle mode logging start, idle mode logging stop, send back log file, delete log file, pause, mobile communication network service domain, and scan state, in which the predefined trouble call contains the situations of call access failure, call discontinuance, handover failure, LA/RA (Location Area/Routing Area) update failure and a low quality event, and indicators for the low quality event is detected by referring to received signal strength indicator (RSSI), ratio of energy per chip and received power density (Ec/Io), block error rate (BLER), channel quality index (CQI) or carrier to interference-plus-noise ratio (CINR). One test sample for any indicator is an average value in a certain user-defined period and the low quality event will be triggered if the test sample count or ratio reaches a user-defined threshold of any indicator in a judgment window which is a definite user-defined duration to decide whether the event happens or not.

According to another embodiment of the present invention, a system for measuring the performance of a mobile network includes a field measurement device with a global positioning system, a server having application software and a built-in command set listing a plurality of command options to operate the field measurement device. The field measurement device further includes a control unit having a first transceiver and a scan unit having a second transceiver. The control unit is capable of obtaining a command script. The scan unit is coupled to the control unit and uses the second transceiver to continuously scan an assigned frequency of the mobile network, and collects measurement data by executing the command script so that the measurement data with geographic location is recorded in a log file, and transmits the log file to the control unit. The server is capable of remotely controlling the field measurement device by sending the command script via the mobile network to the field measurement device for execution and in response receiving the log file from the control unit of the field measurement device via the mobile network, and the log file is imported into the application software to provide analysis and tuning of the mobile network.

The built-in command set is selected from a group consisting of a duration or repetition of mobile origination voice call, duration or repetition of mobile termination voice call, duration or repetition of mobile origination 64 Kbps circuit-switched call, duration or repetition of mobile termination 64 kbps circuit-switched call, upload or download packet-switched call, file size of packet-switched call, repetition of packet-switched call, test call, predefined trouble call, unit management, unit status update, idle mode logging start, idle mode logging stop, send back log file, delete log file, pause, mobile network service domain and scan state, in which the predefined trouble call contains the situations of call access failure, call discontinuance, handover failure, LA/RA (Location Area/Routing Area) update failure and a low quality event, and indicators for the low quality event is detected by referring to received signal strength indicator (RSSI), ratio of energy per chip and received power density (Ec/Io), block error rate (BLER), channel quality index (CQI) or carrier to interference-plus-noise ratio (CINR). One test sample for any indicator is an average value in a certain user-defined period and the low quality event will be triggered if the test sample count or ratio reaches a user-defined threshold of any indicator in a judgment window which is a definite user-defined duration to decide whether the event happens or not.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates an overview of measuring the performance of a mobile network system according to one embodiment of this invention;

FIG. 2 illustrates a field measurement device used in FIG. 1 according to one embodiment of this invention;

FIG. 3 illustrates a field measurement device used in FIG. 1 according to another embodiment of this invention;

FIG. 4 is a flowchart of an operational mode for measuring the performance of a mobile network system according to one embodiment of this invention;

FIG. 5 is a flowchart of an operational mode for measuring the performance of a mobile network system according to another embodiment of this invention; and

FIG. 6 is a flowchart of an operational mode for measuring the performance of a mobile network system according to another embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

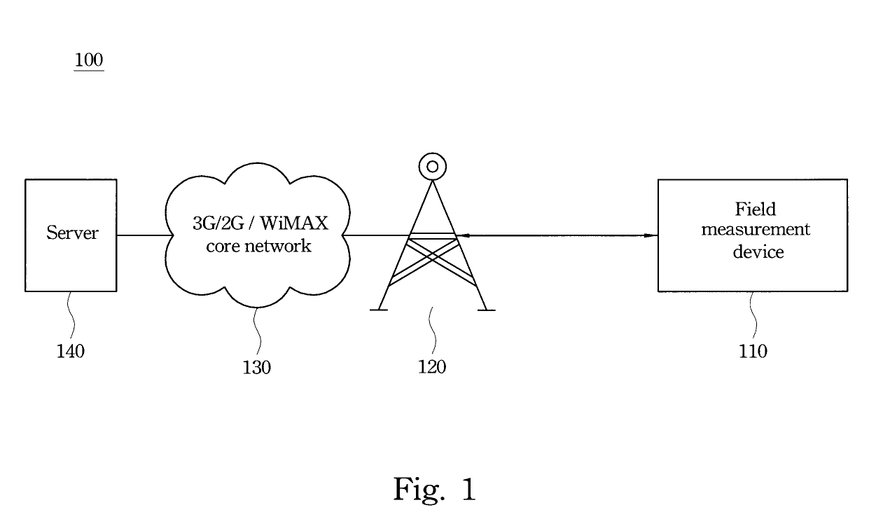

Refer to FIG. 1. The system 100 in FIG. 1 measures mobile network performance according to one embodiment of the present invention. The system 100 includes a field measurement device 110 and a server 140, the field measurement device 110 communicates with the server 140 via a mobile network, e.g. 3G/2G (including GSM/GPRS/EDGE/WCDMA/HSPA) or WiMAX (Worldwide Interoperability for Microwave Access). A base station 120 is coupled to a 3G/2G/WiMAX core network 130 and to an antenna (not shown) as part of the mobile network (3G/2G/WiMAX). Information is transmitted/received via the antenna to/from the field measurement device 110. The server 140 is coupled to the 3G/2G/WiMAX core network 130 to receive log files that are transmitted from the field measurement device 110.

More specifically, the field measurement device 110 continuously scans the assigned frequency of the qualified mobile (3G/2G/WiMAX) stations 120 to collect measurement data. Those skilled in the art know when there are no active services, the traditional device goes into a sleep state in idle mode after finding and camping on a qualified base station, and the traditional device wakes up only in the designed time slot after a long period and checks if there is a call/service destined for the traditional device. Continuously scanning the assigned frequency means the field measurement device 110 never sleeps and continuously collects the measurement data. For example, it is useful to continuously search base stations in the assigned frequency and report the measured qualified pilot channels for 3G/3.5G system with pilot Ec/Io (the ratio of energy per chip and received power density) or for WiMAX system with CINR (Carrier to Interference-plus-Noise Ratio), in order to check the interference of the neighboring cell, and setting the proper neighbor list for a better handover performance; for a 2G system, measuring the received power of broadcast control channel (BCCH) to probe the inter-channel interference and to improve better handover channel assignment is also useful.

The server 140 remotely controls the field measurement device 110 by sending a command script via the mobile network to the field measurement device 110 for execution. The field measurement device 110 executes a command script, records the measurement data into a log file, and then the log file is transmitted back to the server 140 via the mobile network. The log file is imported into the application software (e.g. Actix software etc.) of the server 140 to provide analysis and tuning of the mobile network. The log file is important for analysis of the network performance, including but not limited to: network coverage, network capacity, network throughput, cell handover, call drop or server drop analysis, cell selection and cell reselection analysis, neighboring cell list optimization, and timing critical messages analysis. Particularly, the log file is important for analysis of the WiMAX communication system, including CINR (Carrier to Interference-plus-Noise Ratio), RTD (Round Trip Delay), relative delay and WiMAX G ratio.

The field measurement device 110 may contain a log file selection option such that the measurement data is selectively edited into the log file, wherein the log file selection option may include a full log option, measurement log option, summary log option, sub-sampling option and a selected event log option. The log file may record the time and date when the measurement data is taken, and the system 100 may include a log file search mechanism such that the log file is searched by a specific date/time, geographic location/GPS area.

The log file may contain the following measurement data for network deployment optimization/tuning including but not limited to: received power, transmitted power, pilot Ec/Io, radio bearers, carrier to interference-plus-noise ratio (CINR), round trip delay (RTD), relative delay, WiMAX G ratio, block error rate (BLER), high speed uplink packet access (HSDPA) rate decoding statistic (including block error rates for each used data rate and each transport combination, block retransmission statistics for each rate/each transport combination, effective data rate, etc), channel quality index (CQI, which indicates the measured channel quality for downlink transmission. CQI is measured at a mobile station, and sent from the mobile station to base station), critical messages, events, inter-system border handover, call drops, idle mode information (cell selection, cell reselection, paging responses, inter-RAT (radio access technology), and GPS location information to indicate the location for the event logging.

Referring to FIG. 1, the system 100 further includes a built-in command set that lists a plurality of command options to operate the field measurement device 110. The command set may includes but is not limited to the duration or repetition of mobile origination voice call, duration or repetition of mobile termination voice call, duration or repetition of mobile origination 64 Kbps circuit-switched call, duration or repetition of mobile termination 64 kbps circuit-switched call, upload or download packet-switched call, file size of packet-switched call, repetition of packet-switched call, test call, predefined trouble call, unit management, unit status update, idle mode logging start, idle mode logging stop, send back log file, delete log file, pause, mobile network service domain (e.g. WiMAX/2G/3G, GPS location), and scan state (e.g. WiMAX/2G/3G, GPS location). A summary log file (or summary report) is created by the test call. The summary log file briefs the test content such as testing date, testing time, testing location, call type, call duration, call event, release cause, etc. Besides, the summary log file can be easily post-processed for further statistical analysis, thanks to Extensible Markup Language (XML). The predefined trouble call contains the situations of call access failure, call discontinuance, handover failure, LA/RA (Location Area/Routing Area) update failure and a low quality event. The summary log file and the last-three-minute measurement log file can be fed back immediately for the predefined trouble call. The term “mobile” implies 3G/2G/WiMAX communication network.

For indicators for the low quality event, it can be detected by referring to the indicator, such as received signal strength indicator (RSSI), ratio of energy per chip and received power density (Ec/Io), block error rate (BLER), channel quality index (CQI) or carrier to interference-plus-noise ratio (CINR). One test sample for any indicator is an average value in a certain user-defined period and the low quality event will then be triggered if the test sample count or ratio reaches a user-defined threshold of any indicator in a judgment window, in which the judgment window is a definite user-defined duration to decide whether the event happens or not.

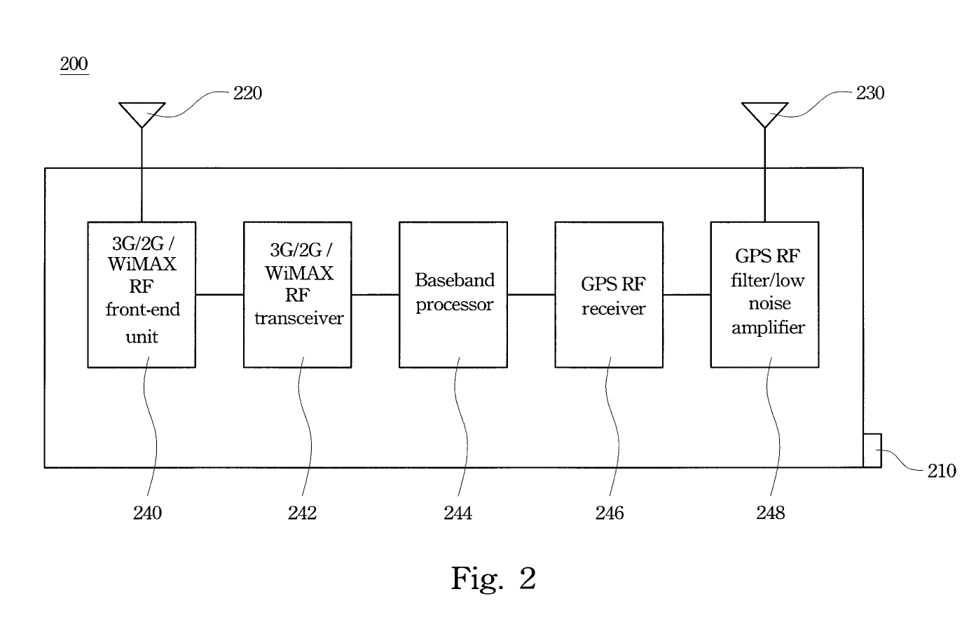

FIG. 2 illustrates a field measurement device used in FIG. 1 according to one embodiment of the invention. The field measurement device 200 includes a transceiver, a GPS (global positioning system), and a USB port 210. Those skilled in the art known that the transceiver may include a 3G/2G/WiMAX antenna 220, a 3G/2G/WiMAX RF front-end unit (e.g. power amplifier, low noise amplifier, filter, switch, or duplexer etc), and a 3G/2G/WiMAX RF transceiver 242; the GPS may includes a GPS antenna 230, a GPS RF filter/low noise amplifier 248, and a GPS RF receiver 246.

The transceiver of the field measurement device 200 is capable of communicating with the server 140 via the mobile network to receive the command script from the server 140, scans a plurality of qualified base stations 120 in order to collect the measurement data, and transmits the log file back to the server 140. The measurement data may use a baseband processor 244 to process the measurement data in order to generate the log file. The GPS of the field measurement device 200 allows the measurement data to be recorded with the geographic location in the log file. The USB port 210 is capable of inputting the command script from an external device (e.g. a computer) for execution.

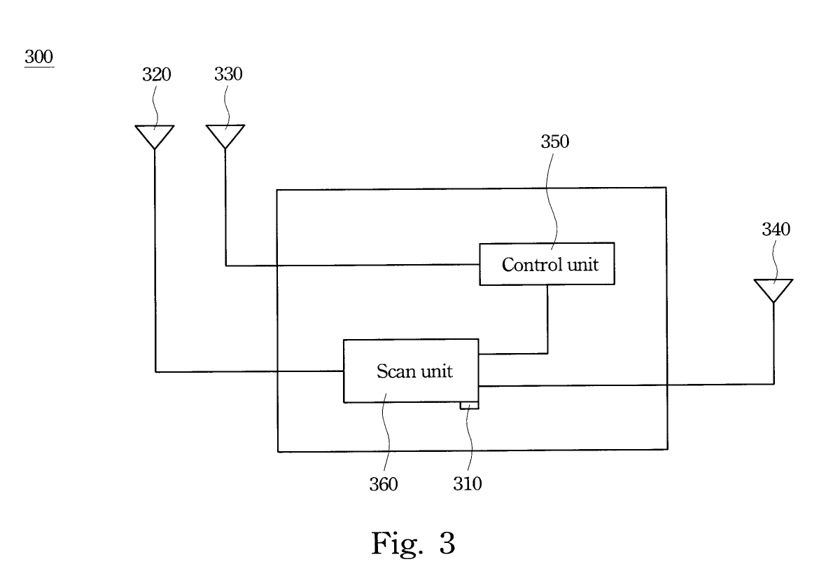

FIG. 3 illustrates a field measurement device used in FIG. 1 according to another embodiment of the invention. The field measurement device 300 includes a control unit 350 having a first transceiver (not shown), a scan unit 360 having a second transceiver (not shown), a GPS (global positioning system, not shown), and a USB port 310. Those skilled in the art know that the first transceiver may include a first antenna 330; the second transceiver may include a second antenna 320; the GPS may include a GPS antenna 340.

The control unit 350 is capable of obtaining a command script from the server 140, and transmitting the log file generated by the scan unit 360 via the first transceiver to the server 140. The control unit 350 is coupled to the scan unit 360 to transmit the command script to the scan unit 360 and in response receive the log file from the scan unit 360.

The scan unit 360 executing the command script and is capable of continuously scanning an assigned frequency using the second transceiver to collect measurement data, using the measurement data to generate the log file, and transmitting the log file back to the control unit 350. The GPS of the field measurement device 300 that allows the measurement data is recorded with geographic location in the log file. The USB port 310 is coupled with the scan unit 310 and is capable of inputting the command script from an external device (e.g. a computer) for execution.

Referring to FIG. 1, the operation of the system 100 for measuring the performance of the mobile network may be triggered by the location of the field measurement device 100, the low quality event or a specific time of a date. Further, the system may include three operational modes: a remote control mode, a server administration mode, and an on-site user mode. The system 100 may set the remote control mode as a default mode.

The remote control mode includes that when mobile communication is first established between the field measurement device 110 and the server 140, the field measurement device 110 checks whether there are any log files, and when there is one log file, the log file is transmitted to the server 140 and the field measurement device 110 executes the command script.

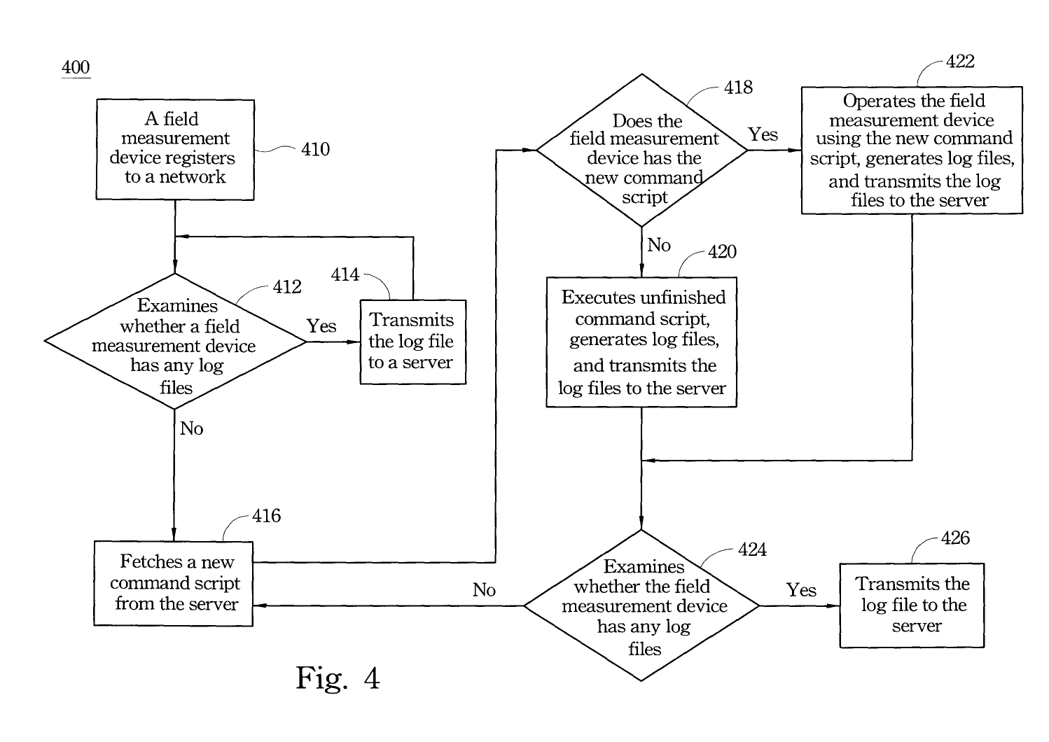

FIG. 4 is a flowchart of a remote control operational mode for measuring the performance of the mobile network system according to one embodiment of the invention. In Step 410, the field measurement device 110 registers and camps on the mobile network. In Step 412, the field measurement device 110 examines whether the field measurement device 110 has any log files (e.g. when the vehicle shuts down power or parks in a no-coverage area, the transmission of the log file back to the server 140 is delayed until the next time the mobile network connection is available). When a log file is present in the field measurement device 110, the field measurement device 110 transmits the log file to the server 140 as shown in Step 414. When there is no log file in the field measurement device 110, the field measurement device 110 fetches a new command script from the server 140 (Step 416). In Step 418, the field measurement device 110 examines whether there is a new command script in the field measurement device 110. When there is a new command script in the field measurement device 110, the field measurement device 110 executes the new command script, generates the log file and transmits the log file to the server 110 (Step 422).

In Step 418, when there is no new command script in the field measurement device 110, the field measurement device 110 executes the unfinished command script, generates the log file, and transmits the log file to the server 140 (Step 420).

After performing Step 422 and Step 420, the field measurement device 110 examines whether the field measurement device 110 has a log file (Step 424). When there a log file is present in the field measurement device 110, the field measurement device 110 transmits the log file to the server 140 (Step 426). When there is no log file in the field measurement device 110, the field measurement device 110 fetches a new command script from the server 140 (Step 416), and then continues with the previously described procedures.

The on-site user mode includes when the field measurement device 200/300 detects an external device plugged into the USB port 210/310, the field measurement device 110 terminates the command script in the field measurement device, executes the command script input via the USB port, and the log file is copied or deleted via the external device. The field measurement device further includes a display panel to display the measurement data on the display panel.

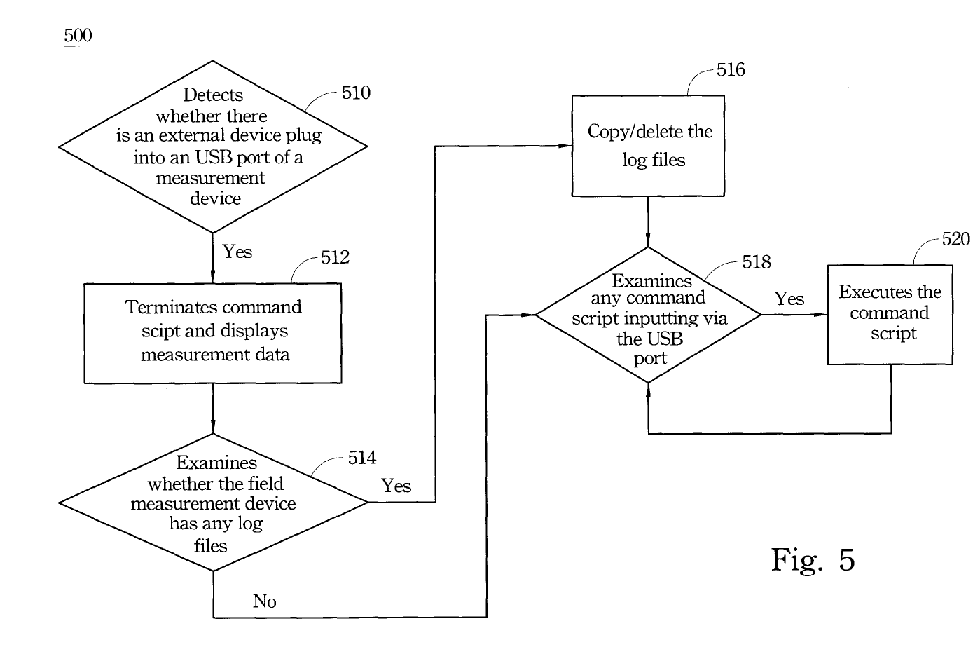

FIG. 5 is a flowchart of an on-site operational mode for measuring the performance of the mobile network system according to another embodiment of the invention. In Step 510, the field measurement device 200/300 detects whether there is an external device plugged into the USB port 210/310. When an external device is plugged into the USB port 210/310, the field measurement device 110 terminates the command script and displays measurement data on a display panel (Step 512). In Step 514, the field measurement device 110 examines whether the field measurement device 200/300 has any log file. When the field measurement device 200/300 has the log file, the user can copy/delete the log files via the USB port 210/310 on site. In Step 518, the field measurement device 110 examines whether there is any command script inputted from the USB port. When a command script is inputted via the USB port 210/310, the field measurement device 200/300 executes the command script (Step 520), and continues to examine whether a command script is inputted via the USB port (Step 518).

In Step 514, when there is no log file in the field measurement device 200/300, the field measurement device 200/300 examines whether a command script is inputted via the USB port 210/310, and then continues with the previously described procedures.

The server administrator mode includes when the field measurement device 100 receives a SMS contains a new server address, the field measurement device 100 terminates the command script in the field measurement device 100, and updates the field measurement device 100 with the new server address such that the command script is fetched from the server 140.

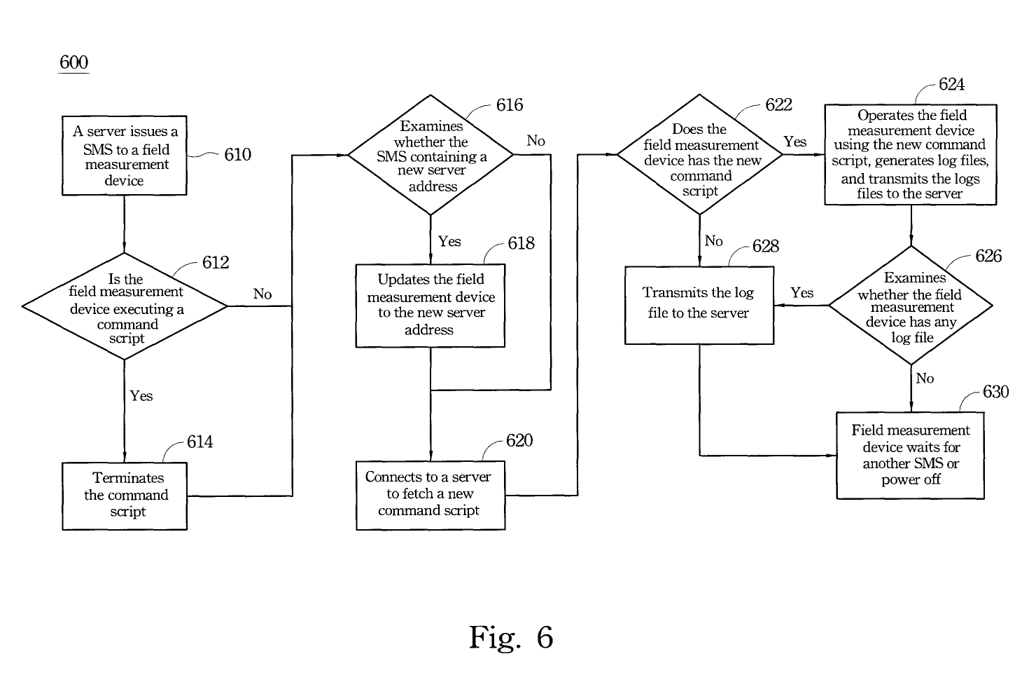

FIG. 6 is a flowchart of a server administrator operational mode for measuring the performance of the mobile network system according to another embodiment of the invention. In Step 610, the field measurement device 110 receives a short message service (SMS) issued from a server 140. In Step 612, the field measurement device 110 examines whether the field measurement device 110 is executing the command script. When the field measurement device 110 is executing the command script, the field measurement device 110 terminates the command script (Step 614). In Step 616, the field measurement device 110 examines whether the SMS contains a new server address. When the SMS contains the new server address, updates the field measurement device 110 to the new server address (Step 618), and connects to a server (e.g. connects to the server with the new server address when the SMS contains the new server address, or do not change the server when the SMS does not contain the new server address) to fetch a new command script (Step 620). In Step 622, the field measurement device 110 determines whether the field measurement device 110 has the new command script. When a new command script is present, the field measurement device 110 executes the new command script, generates the log file, and transmits the log file to the server 140 (Step 624). In Step 626, the field measurement device 110 examines whether the field measurement device 110 has a log file. When the field measurement device 110 has the log file, the field measurement device 110 transmits the log file to the server 140 (Step 628), and then the field measurement device 110 waits for another SMS to power off (Step 630).

In Step 612, when the field measurement device 110 is not executing the command script, the field measurement device 110 examines whether the SMS contains the new server address (Step 616), and then continues with the previously described procedures.

In Step 616, when the SMS does not contain the new server address, the field measurement device 110 connects to the server (Step 620) to fetch a new command script, and then continues with the previously described procedures.

In Step 622, when the field measurement device 110 does not have the new command script, the field measurement device 110 transmits the log file to the server 140 (Step 628), and then continues with the previously described procedures.

In Step 626, when the field measurement device 110 does not have any log file, the field measurement device 110 waits for another SMS or power off (Step 630).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for measuring the performance of a mobile network, comprising:
a field measurement device with a global positioning system capable of continuously scanning an assigned frequency of the mobile network to collect measurement data by executing a command script so that the measurement data with geographic location is recorded in a log file;
a server capable of remotely controlling the field measurement device by sending the command script via the mobile network to the field measurement device for execution and in response receiving the log file from the field measurement device via the mobile network, the log file is imported into an application software to provide analysis and tuning of the mobile network; and
a built-in command set listing a plurality of command options to operate the field measurement device and selected from a group consisting of duration or repetition of mobile origination voice call, duration or repetition of mobile termination voice call, duration or repetition of WiMAX origination 64 Kbps circuit-switched call, duration or repetition of mobile termination 64 kbps circuit-switched call, upload or download packet-switched call, file size of packet-switched call, repetition of packet-switched call, test call, predefined trouble call, unit management, unit status update, idle mode logging start, idle mode logging stop, send back log file, delete log file, pause, mobile communication network service domain, and scan state;
wherein the predefined trouble call contains the situations of call access failure, call discontinuance, handover failure, LA/RA (Location Area/Routing Area) update failure and a low quality event, and indicators for the low quality event is detected by referring to received signal strength indicator (RSSI), ratio of energy per chip and received power density (Ec/Io), block error rate (BLER), channel quality index (CQI) or carrier to interference-plus-noise ratio (CINR), and one test sample for any indicator is an average value in a certain user-defined period and the low quality event will be triggered if the test sample count or ratio reaches a user-defined threshold of any indicator in a judgment window which is a definite user-defined duration to decide whether the event happens or not.

2. The system for measuring the performance of the mobile network of claim 1, wherein the field measurement device further comprises:
a transceiver capable of receiving the command script from the server, scanning a plurality of qualified base stations in order to collect the measurement data, and transmitting the log file back to the server.

3. The system for measuring the performance of the mobile network of claim 1, wherein the field measurement device further comprises a USB port, so that when the field measurement device detects an external device plugged into the USB port, the field measurement device terminates the command script in the field measurement device, executes the command script inputted via the USB port, and the log file is copied or deleted via the external device.

4. The system for measuring the performance of the mobile network of claim 1, wherein the field measurement device further comprises a transceiver communicating with the server to transmit the log file; the field measurement device checks whether there are any log files in the field measurement device when mobile communication is first established between the transceiver of the field measurement device and the server; and when there is one log file, the log file is transmitted to the server and then the field measurement device executes the command script.

5. The system for measuring the performance of the mobile network of claim 1, wherein the field measurement device further comprises a transceiver communicating with the server via the mobile network; when the field measurement device receives an SMS containing a new server address via the transceiver, the field measurement device terminates the command script in the field measurement device and the field measurement device is updated with the new server address such that the command script is fetched from the server with the new server address.

6. The system for measuring the performance of the mobile network of claim 1, wherein the measurement data is selected from the group of received power, transmitted power, energy per chip to received power density ratio, radio bearers, block error rate, HSDPA rate decoding statistics, channel quality index, critical messages, events, handovers, call drops, cell selection, cell reselection, paging response, and inter-RAT.

7. A system for measuring the performance of a mobile network, comprising:
a field measurement device with a global positioning system, comprising:
a control unit having a first transceiver that is capable of obtaining a command script; and
a scan unit having a second transceiver, the scan unit being coupled to the control unit and using the second transceiver to continuously scan an assigned frequency of the mobile network, and collect measurement data by executing the command script so that the measurement data with geographic location is recorded in a log file, and transmits the log file to the control unit;
a server capable of remotely controlling the field measurement device by sending the command script via the mobile network to the field measurement device for execution and in response receiving the log file from the control unit of the field measurement device via the mobile network, the log file is imported into an application software to provide analysis and tuning of the mobile network; and
a built-in command set listing a plurality of command options to operate the field measurement device and selected from a group consisting of a duration or repetition of mobile origination voice call, duration or repetition of mobile termination voice call, duration or repetition of mobile origination 64 Kbps circuit-switched call, duration or repetition of mobile termination 64 kbps circuit-switched call, upload or download packet-switched call, file size of packet-switched call, repetition of packet-switched call, test call, predefined trouble call, unit management, unit status update, idle mode logging start, idle mode logging stop, send back log file, delete log file, pause, mobile network service domain and scan state;
wherein the predefined trouble call contains the situations of call access failure, call discontinuance, handover failure, LA/RA (Location Area/Routing Area) update failure and a low quality event, and the low quality event is detected by referring to received signal strength indicator (RSSI), ratio of energy per chip and received power density (Ec/Io), block error rate (BLER), channel quality index (CQI) or carrier to interference-plus-noise ratio (CINR), and indicators for the low quality event is detected by referring to received signal strength indicator (RSSI), ratio of energy per chip and received power density (Ec/Io), block error rate (BLER), channel quality index (CQI) or carrier to interference-plus-noise ratio (CINR), and one test sample for any indicator is an average value in a certain user-defined period and the low quality event will be triggered if the test sample count or ratio reaches a user-defined threshold of any indicator in a judgment window which is a definite user-defined duration to decide whether the event happens or not.

8. The system for measuring the performance of the mobile network of claim 7, wherein the field measurement device further comprises a USB port, so that when the field measurement device detects an external device plug into the USB port, the field measurement device terminates the command script in the field measurement device, executes the command script inputted via the USB port, and the log file is copied or deleted via the external device.

9. The system for measuring the performance of the mobile network of claim 7, wherein the field measurement device uses the first transceiver to communicate with the server to transmit the log file; when the mobile network is first established between the field measurement device and the server, the field measurement device checks whether there are any log files in the measurement device; and when there is one log file, the log file is transmitted to the server and then the field measurement device executes the command script.

10. The system for measuring the performance of the mobile network of claim 7, wherein the field measurement uses the first transceiver to communicate with the server via the mobile network, when the field measurement device receives an SMS containing a new server address via the first transceiver, the field measurement device terminates the command script in the field measurement device and updates the field measurement device with the new server address such that the command script is fetched from the server with the new server address.

11. The system for measuring the performance of the mobile network of claim 7, wherein the measurement data is selected from the group of received power, transmitted power, energy per chip to received power density ratio, radio bearers, block error rate, HSDPA rate decoding statistics, channel quality index, critical messages, events, handovers, call drops, cell selection, cell reselection, paging response, and inter-RAT.
